(19) United States
(12) Patent Application Publication
(10) Pub. No.: US 2001/0044820 A1
(43) Pub. Date: Nov. 22, 2001

(54) Method and system for website content integrity assurance

(76) Inventor: Adam Marc Scott, Ashburn, VA (US)

Correspondence Address: George T. Marcou, Kilpatrick Stockton LLP, Suite 900, 607 14th Street, NW, Washington, DC, 20005, US

(21) Appl. No.: 09/826,856

(22) Filed: Apr. 6, 2001

Related U.S. Application Data
(60) Provisional application No. 60/194,893, filed on Apr. 6, 2000.

(51) Int. Cl. G06F 15/16

(52) U.S. Cl. 709/202

(57) ABSTRACT

An improved method and system for monitoring and detecting changes to static, dynamic, and active web content is disclosed. The system includes a web detection manager, a web detection agent, and a web detection console. The web detection console configures the web detection manager to monitor at least one web page. The web detection manager requests web site information from the web detection agent. The web detection agent provides the web detection manager with the requested web site information and the web detection manager processes that information to determine whether the content of each web page being monitored has been altered. The web site information includes the encoded content of each web page being monitored.

### CROSS-REFERENCE TO RELATED APPLICATIONS

The current application claims priority to provisional application number 60/194,893 filed Apr. 6, 2000 entitled, “METHOD AND SYSTEM FOR WEBPAGE INTEGRITY ASSURANCE,” which is incorporated herein by reference in its entirety.

### BACKGROUND OF THE INVENTION

1. Field of the Invention

The present invention relates to the monitoring of web sites for changes to static, dynamic, and active web content. The present invention further relates to a system and method that can be used to quickly determine web content changes, unavailable web pages, and web server domain hijacking.

2. Description of Related Art

Over the last fifteen years the Internet has grown dramatically. People have become dependent on the Internet to advertise, disseminate information, and conduct electronic commerce. As the Internet has developed, however, so has the number of threats to its safe operation.

In order to understand these threats, it is important to understand what the Internet is and how information is transmitted and received from the Internet to a host computer. The Internet is the world's largest network of networks. A host computer does not really connect to the Internet, but to a network that is eventually connected to the Internet backbone. FIG. 1 shows an example of Internet connected networks. In this example, host computers 5 are directly connected to an Internet Service Provider (ISP) 10, connected to a company network backbone 15 that is connected to an ISP 10, or connected to a local area network (LAN) 20 that is connected to a company network backbone 15 that is connected to an ISP 10. The ISPs, in turn, are then connected to the Internet backbone 25. Although, as illustrated in FIG. 1, the Internet is made up of a wide variety of host computers, from supercomputers to personal computers using every conceivable type of hardware and software available, all these computers are able to understand each other and work together.

They are able to work together because of the Transport Control Protocol/Internet Protocol (TCP/IP). TCP/IP is the language of the Internet. TCP is a transport-layer protocol. IP is a network-layer protocol. Since TCP and IP were designed together, typically they are found together. Thus, the entire suite of Internet protocols are known collectively as TCP/IP.

TCP itself has a number of important features including guaranteed packet delivery. Packets (a.k.a. datagrams) are pieces of messages transmitted over an IP network. One of the key features of a packet is that it contains a destination address in addition to the data. Guaranteed packet delivery works as follows: if Host A sends packets to Host B, Host A expects to get an acknowledgement back for each packet sent. If Host B does not send an acknowledgement within a specified amount of time, Host A will resend the packet. Host B, on the other hand, expects a data stream to be complete and in order. As noted, if a packet is missing, it will be resent by Host A, but if a packet arrives out of order, Host B will arrange the packets in the proper order before passing the data stream to a requested application.

IP is the layer that allows the hosts to actually “talk” to each other. The IP is responsible for a variety of tasks including carrying datagrams, mapping Internet addresses to physical network addresses, and routing. A number of attacks are possible against the IP. Typically, these attacks exploit the fact that IP does not have a robust mechanism for authentication. Authentication in this context means proving that a packet came from where it claims it did.

One such attack is called IP spoofing. IP spoofing is where one host claims to have the IP address of another host. Since many systems (such as router control lists) define which packets may and which packets may not pass based on the sender's IP address, an attacker can use this technique to send packets to the host causing the host to take some type of action.

Another possible attack is called IP session hijacking. IP session hijacking is an attack whereby a user's session is taken over by an attacker. In this attack, a user on Host A carries on a session with Host B. Host X, which is run by the attacker, exists somewhere in the network between Host A and Host B. The attacker on Host X watches the network traffic between Host A and Host B and runs a tool that impersonates Host A and at the same time tells Host A to stop sending information. To Host A it appears as if the connection to Host B has dropped perhaps due to some type of network problem, when in reality Host X has now hijacked Host A's session with Host B.

In addition to the specific attacks discussed above, there are general types of threats that are commonly launched against networked computers. On such type is called Denial-of Service (DoS). DoS attacks are easy to launch and difficult (sometimes impossible) to track. The premise of DoS attack is simple: send more requests to a computer than it can handle. The attacker's program simply makes a connection on some service port, forges the packet's header information that says where the packet came from, and then drops the connection. If the host computer is able to answer 20 requests per second, then the attacker sends 50 requests per second. As a result, the host computer will be unable to service all the attacker's requests, much less any legitimate requests.

Another type of threat can be broadly classified as unauthorized access. Unauthorized access refers to a number of different attacks. The goal of these attacks is to access some resources that the computer would not normally provide to the attacker. An attacker who gains unauthorized access to a web server as an administrator, for example, can do untold damage, including changing the server IP address, putting a start-up script in place to cause the host to shut down every time it is started, etc.

Another type of threat is referred to as destructive behavior. Among destructive sorts of attacks, there are two major categories: data manipulation; and data destruction. Data manipulation is simply the manipulation of some data on the host computer. These attacks are perhaps the worst, since the break-in may not be immediately obvious. If an attacker, for example, only changes the numbers on some spreadsheets, it may take months (if ever) before those changes are detected. Data destruction, on the other hand, is the deletion of some data on the host computer. While these changes may be more easily noticeable, they are devastating and can completely destroy the host computer.

In the past, protection has been considered to be the most critical aspect of any security strategy. Fundamentally, any solution that did not seek to prevent information from being stolen, corrupted, or denied was not considered a useful solution. The classic protection tool is the network firewall. Firewalls act as a barrier between a host computer/host network and the outside world (i.e. the Internet), and filter incoming traffic according to any number of configurable parameters. Protection, however, is no longer sufficient to meet the rising standard of due care with regard to information protection. A single-dimensional network security approach is no longer adequate because: 1) not all access to the Internet occurs through a firewall; 2) not all threats originate outside a firewall; and 3) firewalls are subject to attack themselves.

For a variety of reasons, users sometimes set up unauthorized modem connections between their computers and outside Internet access providers or other avenues to the Internet. If the user's computer is also connected to an internal network, the user has created a potential security breach. A firewall cannot mitigate risks associated with connections it cannot detect.

Most computer and network security incidents can be traced back to insiders. As previously stated, a firewall is only able to regulate traffic at the cusp between the internal network and the Internet. If the security breach comes from traffic that the firewall does not monitor, then it cannot stop the problem.

Firewalls are not foolproof. There are a variety of attacks and strategies for circumventing firewalls. One common attack strategy is to use tunneling to bypass firewall protections. Tunneling is the practice of encapsulating a message in one protocol (one that would normally be blocked by the firewall) inside a second protocol that the firewall will allow through.

As shown above, firewalls are not the panacea of network security protection. As such, they can no longer be relied upon as the sole network security solution. A multi-dimensional approach is necessary to discourage sophisticated threats. A good information protection policy must include protection, detection and reaction. While it is extremely important to protect a system as best as is technically possible within acceptable resource constraints, it is equally important to have mechanisms in place to detect unauthorized activity and to have procedures to react to such events. Since it is neither usually possible nor even reasonable to protect against unknown vulnerabilities, a sound security approach should include detection and reaction practices and procedures.

Conventional web site change detection systems request the monitored web pages remotely. In this manner, the entire contents of the requested web pages are sent across the Internet. This method uses large amounts of bandwidth and since the web pages are processed before the contents are sent, the sent data includes dynamic content. Such dynamic content falsely sets off conventional web site change detection systems. For example, some web pages include the current date. When the content of these monitored web sites are requested, the date is dynamically included such that the sent content incorporates the date. Conventional change detection systems would detect a changed date as an unauthorized alteration of the monitored web site and would take action accordingly.

### SUMMARY OF THE INVENTION

What is needed is a system and method for monitoring a web site, which detects changes to information stored on the web site and responds accordingly. Further, what is needed is a system and method for monitoring web sites that is not bandwidth intensive and that will correctly monitor dynamic and active content without generating false positives.

One embodiment of the present invention is directed to a web site integrity detection system for detecting changes in web page content within a web site. The system includes a web detection manager, a web detection agent, and a web detection console. The web detection console configures the web detection manager to monitor at least one web page. The web detection manager requests web site information from the web detection agent. The web detection agent provides the web detection manager with the requested web site information and the web detection manager processes that information to determine whether the content of each web page being monitored has been altered. The web site information includes the encoded content of each web page being monitored.

In another embodiment of the present invention a method for protecting web site data integrity is disclosed. The method includes the steps of requesting web site information from a web detection agent, receiving the web site information transmitted by the web detection agent, comparing the web site information to stored, baseline web site information and notifying at least one point of contact if the web site information differs from the stored web site information. The web site information, according to this embodiment of the present invention, includes the encoded content of each web page being monitored.

Another embodiment discloses a method for protecting web site data. The method involves three computer programs: a web detection console program, a web detection agent program and a web detection manager program. The web detection agent and the web detection manager program reside on different computers that are in electronic communication with each other. The web detection console program allows a user to specify at least one web site to be monitored, one or more web pages within the web site to be monitored, the frequency with which the web pages will be monitored, at least one person to be contacted if an unauthorized change in the web site is detected, and a communication means for contacting that person. The web detection agent program transmits web site information, which includes the encoded content of each web page being monitored, to the web detection manager. The web detection manager program requests the web site information from the web detection agent program and processes the web site information to determine whether the content of each web page being monitored has been altered.

Other features, advantages, and embodiments of the invention are set forth in part in the description that follows, and in part, will be obvious from this description, or may be learned from the practice of the invention.

### BRIEF DESCRIPTION OF THE DRAWINGS

The foregoing and other features and advantages of this invention will become more apparent by reference to the following detailed description of the invention taken in conjunction with the accompanying drawings.

FIG. 1 shows an example of Internet connected networks.

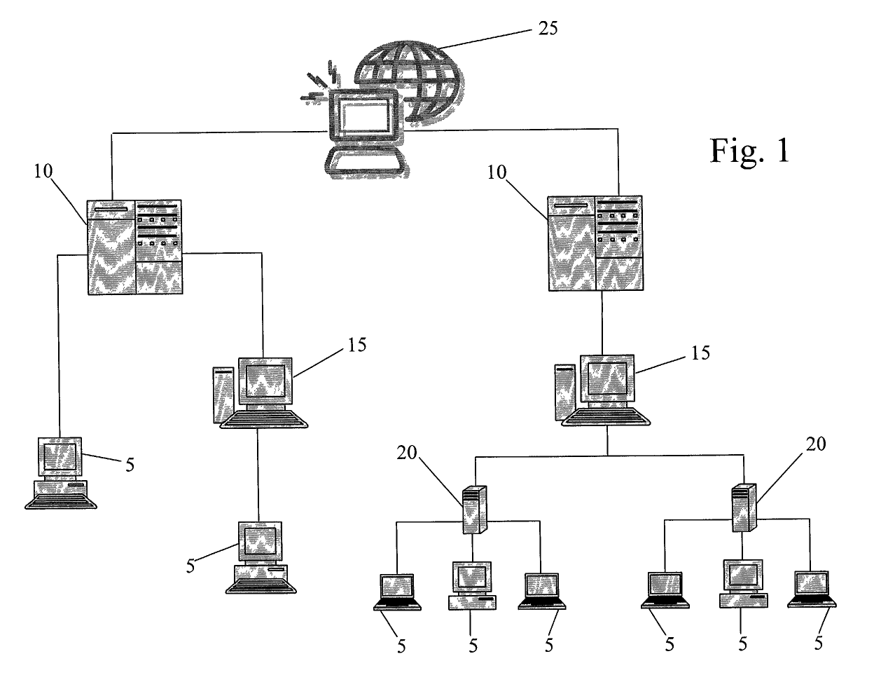

FIG. 2 depicts a portion of the functionality of the Web Detection System.

FIG. 3 describes a method of selecting web pages to be monitored.

FIG. 4 shows additional functionality of the Web Detection System.

FIG. 5 describes a method of monitoring a web site.

FIG. 6 describes a method of gathering baseline monitoring information.

FIG. 7 describes a method for notifying a contact person using two-way communications.

### DETAILED DESCRIPTION OF THE PREFERRED EMBODIMENTS OF THE INVENTION

As embodied and broadly described herein, the preferred embodiments of the present invention are directed to a system and method for ensuring website content integrity. The system and method can detect changes to web pages, web site hijacking and server outages. The present invention is composed of several discrete software applications, which together make up a web site integrity detection system (hereinafter web detection system). Those applications include a web detection console (hereinafter console), and web detection manager (hereinafter manager) and a web detection agent (hereinafter agent). The console is used to configure the web detection system, specifically the manager. The manager requests web site information from the agent and the agent provides the manager with the requested data.

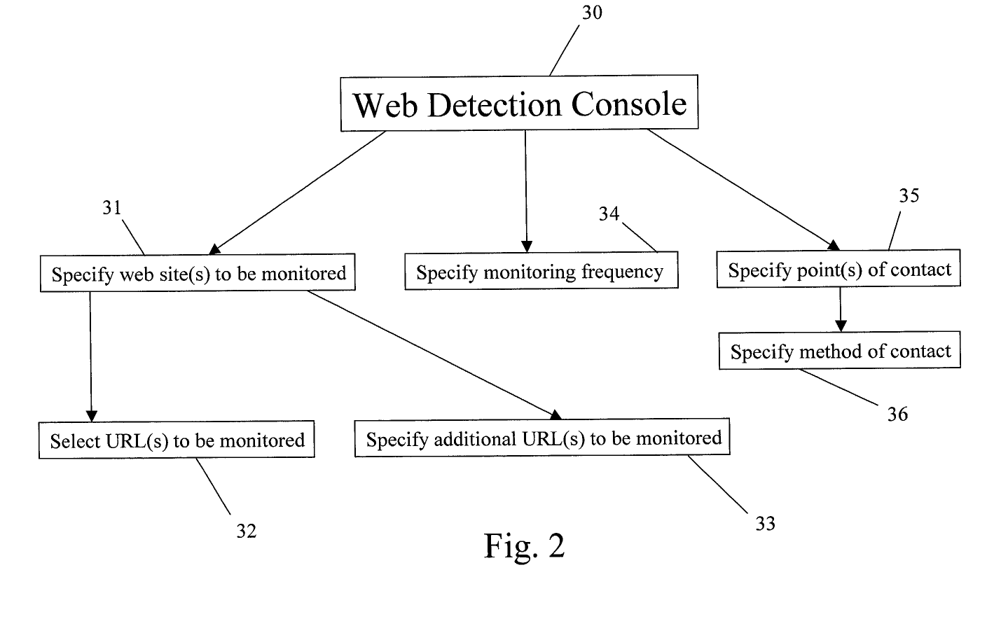

As shown in FIG. 2, the console 30 allows a user to specify at least one web site to be monitored 31, the frequency in which the web site is monitored 34 and at least one point of contact 35 to be notified in the event the content of the web site being monitored is altered. In addition to allowing the user to specify at least one web site 31 to be monitored, the console 30 provides increased flexibility by allowing a user to specify specific web page(s) within the web site to be monitored. Practically speaking, any system content that is readable by the permission of the web server may be specified. For purposes of the present invention, the term web page includes, but is not limited to, any text, graphic, database or table, that is contained within the web site being monitored 31. The console 30 provides this flexibility by allowing users to select and/or specify specific uniform resource locators (URLs) within the monitored web site. These URLs may address any web page contained within the web site being monitored 31.

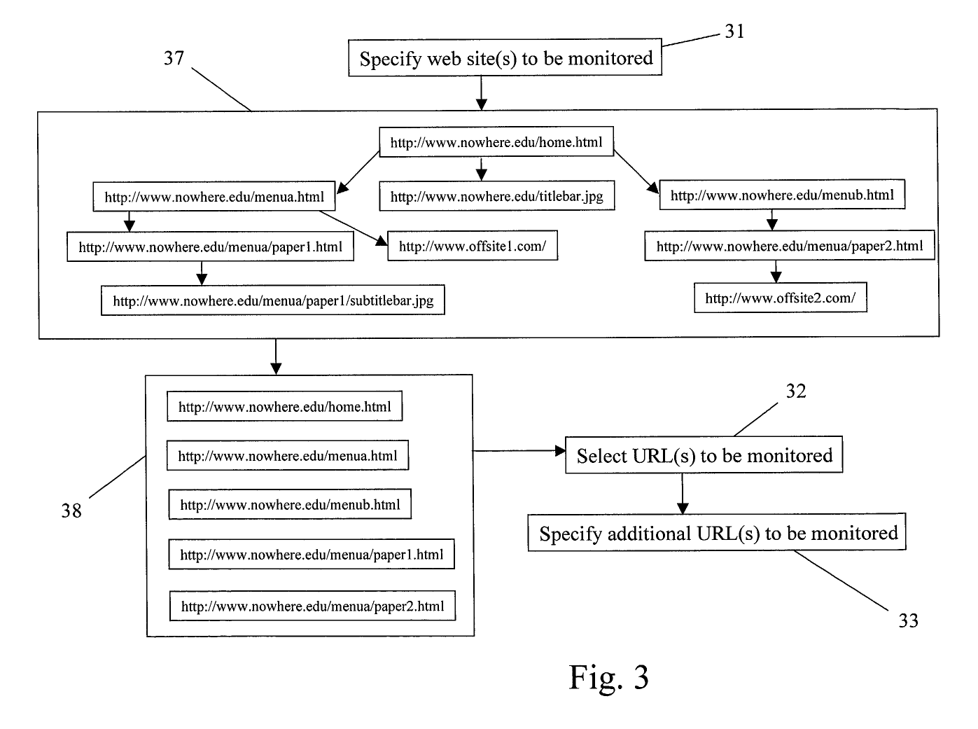

As shown in FIG. 3, once the user has specified at least one web site to be monitored 31, the manager traverses (a.k.a. spiders) the web site 37 to obtain a list of URLs 38 that are contained within the web site 31. The user is prompted to enter the homepage URL of the web site to be monitored. As shown in FIG. 3, by way of example, this would be www.nowhere.edu/home.html. The web detection system proceeds to traverse the web page associated with the homepage URL, searching for URLs to other web pages (i.e. www.nowhere.edu/menua.html, www.nowhere.edu/titlebar.jpg, www.nowhere.edu/menub.html) contained therein. The web detection system proceeds, in turn, to traverse each of the web pages associated with those URLs (i.e. www.nowhere.edu/menua.html, www.nowhere.edu/titlebar.jpg, www.nowhere.edu.menub.html) searching for other URLs until the entire web site is traversed. The web detection system then generates a list 38 of the URLs for all web pages contained within the web site. Since the URLs, www.offsite1.com and www.offsite2.com, address web pages that are not contained within the web site being monitored 31, those URLs are not included in the list 38. That is not to say that the URLs to www.offsite1.com and www.offsite2.com are not monitored by the web detection system, but simply that the content of www.offsite1.com and www.offsite2.com is not monitored. Since the URLs to www.offsite1.com and www.offsite2.com are contained within the web pages, www.nowhere.edu/menua.html and www.nowhere.edu/paper2.html, respectively, the links to both www.offsite1.com and www.offsite2.com are monitored for changes. Thus, if the link to www.offsite1.com is changed to www.offsite3.com, the web detection system would detect such a change. After the console 30 generates the list 38 of the URLs of all web pages contained within the monitored web site, the user may specify exactly which web pages are to be monitored by selecting the appropriate corresponding URL 32. In at least one embodiment of the present invention, the user is also given the option of specifying additional URLs to be monitored 33 that are not contained within the list 38.

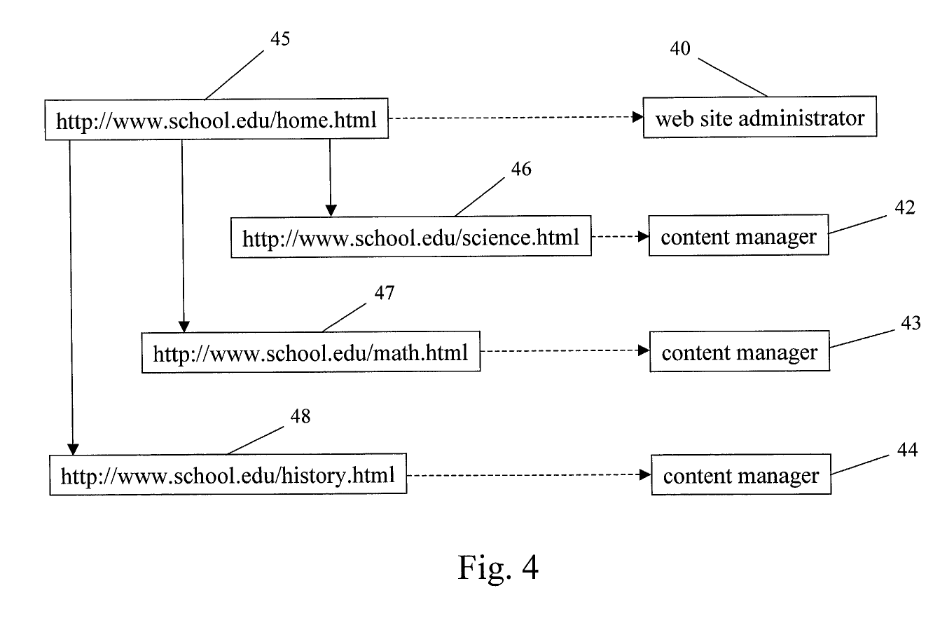

As stated above, the console 30 allows the user to specify at least one point of contact 35 to be notified in the event a change is detected in the monitored web site. In at least one embodiment of the present invention, as shown in FIG. 4, the console 30 provides for a hierarchy of users. Points of contact may be assigned to an entire web site or portion thereof.

The console 30 allows points of contact to be assigned as “web site administrators” or “content mangers.” Web site administrators have all rights possessed by content managers, as well as, the additional right to create content managers. In this way, a web site administrator may manage multiple web sites or portions of web sites with content managers assigned to portions of those web sites. As shown in FIG. 4, by way of example, the monitored web site has a homepage www.school.edu/home.html 45 and three web pages representing three different departments within the school. Those three web pages are www.school.edu/science.html 46, www.school.edu/math.html 47 and www.school.edu/history.html 48. As shown in FIG. 4, the web site administrator 40 is assigned to the homepage, www.school.edu/home.html 45, first content manager 42 is assigned to www.school.edu/science.html 46, second content manager 43 is assigned to www.school.edu/math.html 47 and third content manager 44 is assigned to www.school.edu/history.html 48. In the event a change is detected in the content of the monitored web site, the web site administrator 40 or content manager 42, 43, or 44, assigned to the web page where the change is detected will be notified. It is important to note that there may be multiple web site administrators assigned to a single monitored web site. It is also important to note that web site administrators and content managers may be assigned to web pages contained within the monitored web site in any conceivable combination, including, but not limited to, a web site administrator assigned to a web page, a content manager assigned to a web page, multiple web site administrators assigned to a web page, multiple content managers assigned to a web page, and a web site administrator and a content manager assigned to a web page.

In addition to specifying at least one point of contact to be notified in the event that a change is detected within the monitored web site, the console 30 allows the user to specify a means in which the points of contact will be notified 36. Such means 36 include, but are not limited to, page, email, fax and phone call. In fact, it is contemplated that any wireless or wired communication service may be used to notify the points of contact 35.

Once the console configures the manager, the manager requests web site information from the agent in order to establish a baseline reading of the monitored web site. The manger and the agent are in electronic communication across a network. In a preferred embodiment, the electronic connection is across an open network (i.e. the Internet). In a preferred embodiment of the present invention, the manager resides on a computer at a Security Operations Center (SOC), while the agent resides on the web server that contains the web site being monitored. While the agent can be configured to operate on any web server, according to a preferred embodiment, the web server is any computer system running a hypertext transport protocol (HTTP) based server application, including, but not limited to, Microsoft's Internet Information Server running on Windows NT, Netscape's Enterprise Server running on Unix or Windows NT, or Apache Server running on Linux.

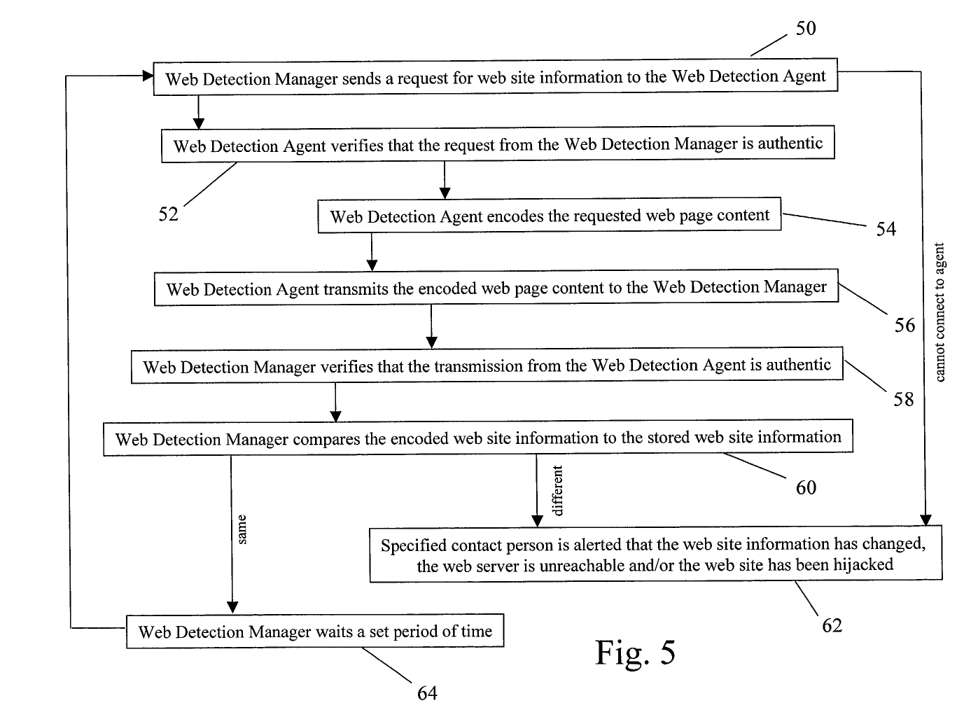

After the manager has successfully obtained and stored a baseline reading of the monitored web site, the web detection system will begin to actively monitor the specified web site according to the parameters/options that were specified in the console. As seen in FIG. 5, the process begins with the manager sending a request for web site information to the agent 50 on the web server. If the manager cannot establish a connection to the agent after a number of repeated attempts or after a period of time, the manager will consider the web server unreachable and will notify the contact person(s) 62 specified by the user in the console. This additional feature of the present invention allows the web detection system to notify the specified point(s) of contact if the web server is unreachable because a required network segment is unavailable, an ISP is down, a server crashed or for any other reason. In a preferred embodiment of the present invention, the request from the agent uses an HTTP protocol. Other protocols known to one of skill in the art, however, may also be used. The request includes a list of the URLs for each of the web pages selected for monitoring. In at least one embodiment of the present invention, the agent verifies that the request from the manager is authentic 52. In a preferred embodiment, a public key mutual client/server authentication mechanism is used. It is contemplated that other authentication mechanisms may also be used, including, but not limited to, shared secret and digital certificates.

The request calls a common gateway interface (CGI) script on the web server and it is that script that gathers the requested web site information. In a preferred embodiment, the CGI script is programmed in C++, however, other languages, including, but not limited to, Visual Basic, Perl, and Java, may also be used. The script encodes the contents of each of the web pages being monitored 54. In a preferred embodiment, the agent encodes the contents by calculating a hash value for the contents of each of the web pages being monitored. It is contemplated that other encoding schemes known to one skilled in the art may also be used. By encoding the contents of each of the web pages being monitored server-side, the web detection system is able to monitor any file/document on the web server, including, but not limited to, text, graphics, databases and tables. Also, since the web detection system encodes the contents of each source file/document, the system is able to monitor dynamic web content (i.e. Macromedia, DHTML, Java, etc.) as well as traditional static content.

Once the agent has encoded the contents of each of the web pages being monitored, the agent transmits the encoded content 56 to the manager. It is important to note that only the encoded web site information is transmitted from the web server. The actual contents of the web pages being monitored are not transmitted, thereby limiting bandwidth requirements. In a preferred embodiment of the present invention, the encoded content transmitted to the manager is encrypted. While Secure Socket Layer (SSL) technology is preferably used to encrypt the transmitted data stream, other encryption technologies known to one of skill in the art may also be used. In at least one embodiment of the present invention, the manager verifies that the transmission from the agent is authentic 58. In a preferred embodiment, a public key mutual client/server authentication mechanism is used. It is contemplated that other authentication mechanisms known to one of skill in the art may also be used, including, but not limited to, shared secret and digital certificates.

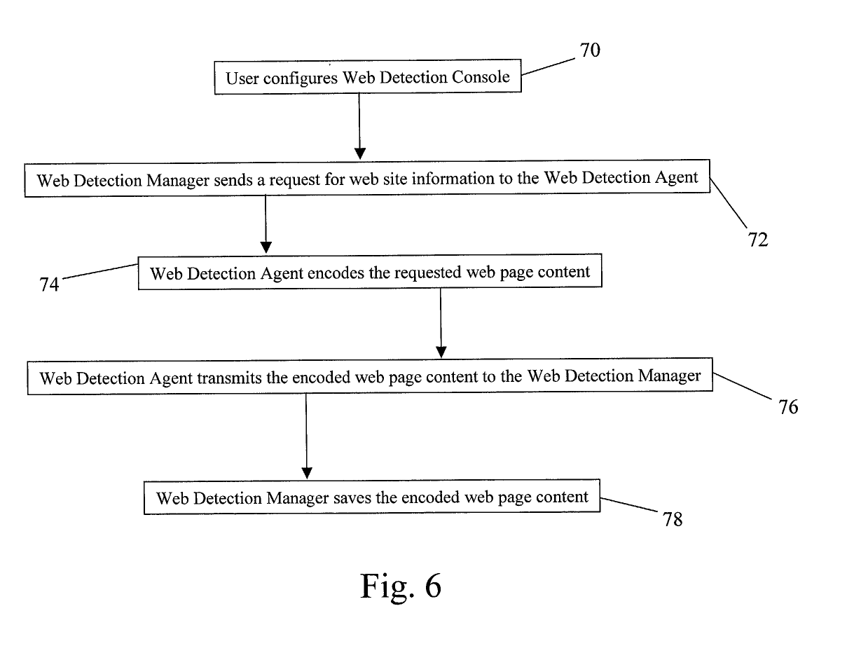

The manager then compares the transmitted, encoded web site information to stored, baseline web site information 60. The baseline information is obtained much the same way as the procedure outlined above and is shown in FIG. 6. Once the user configures the console 70, the manager will send a request for web site information to the agent 72. The request will contain a list of all the URLs of the web pages being monitored. The agent will then encode the contents of each of the web pages being monitored 74 and transmit the encoded web site information back to the manager 76. This information is saved by the manager 78 and becomes the baseline web site information. According to one embodiment, at the time when the baseline information is collected, the entire contents of the web pages being monitored are transmitted to the manager and stored. In this embodiment, the entire contents are not encoded. Thus, if the contents of a web page being monitored is later altered, a clean copy of the web page content is available for restoration.

If the manager determines that the encoded web site information is the same as the stored, baseline information, the manager will take no action and will repeat the procedure outlined in FIG. 5 after a set period of time 64 as specified by the user in the console. If the comparison between the encoded web site information and the stored, baseline web site information reveals that the contents of the web site being monitored have been altered, the manager will notify the contact person(s) that the user specified in the console 62.

The manager will notify the specified contact person(s) in the manner in which the user specified in the console. As previously stated, the means in which the manager can notify the contact person(s) are many. Such means 36 include, but are not limited to, page, email, fax and phone call. In fact, it is contemplated that any wireless or wired communication service/protocol, including, but not limited to, cell phone, personal data assistant (PDA), Simple Mail Transfer Protocol (SMTP), Simple Network Paging Protocol (SNPP) may be used to notify the points of contact 35. In one embodiment of the present invention, an interactive voice response (IVR) system is used to notify the specified contact person(s).

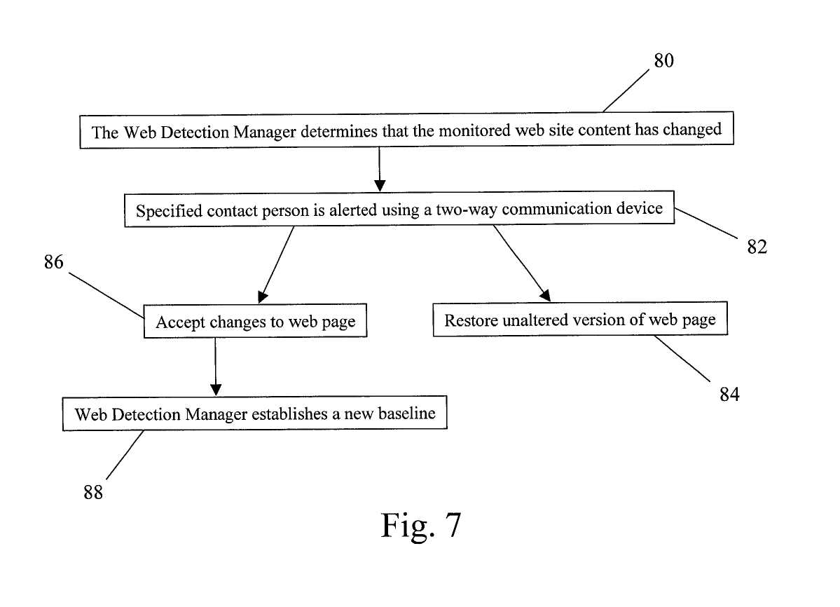

According to another embodiment, as shown in FIG. 7, two-way communication systems/protocols, including, but not limited to, IVR, SMTP, SNPP, and two-way paging, give users the ability to interact with the manager or SOC. Once the manger determines that the monitored web site content has been altered 80, the manager notifies the specified contact person(s) using the specified two-way communication device 82. The manager provides the contact person(s) with the URL of the web page that has been altered and a series of options. The options, according to an embodiment, allow the user to restore an unaltered copy of the changed web page 84 or accept the changes made to the web page 86. If the user elects to accept the changes, the manager will save the most recent encoded web site information as the new baseline web site information 88.

According to another embodiment, the present invention can be configured to interact with load balancers. Load balancers distribute processing and communications activity across a computer network so that no single device is overwhelmed. In one embodiment, the load balancing system includes a plurality of servers each having a copy of all web pages that are served. If the manager detects a content change on one of the web servers, the manger can contact at least one person as outlined above and shown in FIGS. 2, 5, and 7 or can be setup to automatically disable the web server where the change was detected. If one of the web servers goes down, the manager will interact with the load balancer to disable the malfunctioning web server.

Other embodiments and uses of the present invention will be apparent to those skilled in the art from consideration of this application and practice of the invention disclosed herein. The present description and examples should be considered exemplary only, with the true scope and spirit of the invention being indicated by the following claims. As will be understood by those of ordinary skill in the art, variations and modifications of each of the disclosed embodiments, including combinations thereof, can be made within the scope of this invention as defined by the following claims.

What is claimed is:

1. A web site integrity detection system for detecting changes in the content of one or more web pages within a web site on a web server, comprising:
a web detection manager;
a web detection agent; and
a web detection console,
wherein the web detection console configures the web detection manager to monitor the web site, the web detection manager requests web site information about the one or more web pages from the web detection agent and processes the web site information to determine whether the content of the one or more web pages has been altered, and the web detection agent provides the web detection manager with the web site information by encoding the content of the one or more web pages of the web site and transmitting the encoded content to the web detection manager.

2. The system of claim 1, wherein the one or more web pages are chosen by selecting one or more uniform resource locators associated with the one or more web pages, the one or more uniform resource locators chosen from a list of uniform resource locators associated with the web site.

3. The system of claim 2, wherein the list of uniform resource locators is generated by:
(1) traversing the home page of the web site to be monitored by the web site integrity detection system for uniform resource locators;
(2) storing the uniform resource locators;
(3) for the uniform resource locators that address additional web pages contained within the web site, traversing the additional web pages for any additional uniform resource locators; and
(4) repeating steps (2) and (3) until all uniform resource locators that address additional web pages within the web site have been traversed.

4. The system of claim 1, wherein the web detection console allows a web site administrator to:
specify the web site to be monitored; and at least one of
specify at least one point of contact that will be contacted if the web detection manager determines that the content of the one or more web pages of the web site has been altered,
set the frequency that the web detection manager requests the web site information, and
specify the one or more web pages by selecting their corresponding uniform resource locators from a list of uniform resource locators associated with the web site.

5. The system of claim 1,
wherein the web detection manager is a software application that resides on a first computer at a first location;
wherein the web detection agent is a software application that resides on a second computer at a second location; and
wherein the first location is in communication with the second location over an open network.

6. The system of claim 1, wherein the encoded content comprises at least one calculated hash value.

7. The system of claim 1, wherein the web site information transmitted by the web detection agent is encrypted.

8. The system of claim 1, wherein the web detection agent authenticates the request for the web site information.

9. The system of claim 1, wherein the web detection manager authenticates a response to the request for the web site information.

10. The system of claim 1, wherein the web detection console configures the web detection manager to contact at least one point of contact if the web detection manager determines that the content of at least one web page of the one or more web pages has been altered.

11. The system of claim 10, wherein the one or more web pages is associated with one or more uniform resource locators, wherein the at least one web page is associated with at least one uniform resource locator, wherein each point of contact of the at least one point of contact is associated with a uniform resource locator of the at least one uniform resource locator, wherein the at least one point of contact is configured as a web site administrator or a content manager, and wherein the web site administrator has authority to add a new content manager and specify the uniform resource locator of the one or more uniform resource locators to be associated with the new content manager.

12. A method for protecting the data integrity of one or more web pages within a web site, comprising the steps of:
requesting web site information from a web detection agent;
receiving the web site information transmitted by the web detection agent, wherein the web detection agent generates the web site information by encoding the content of the one or more web pages;
comparing the web site information to stored, baseline web site information; and
notifying at least one point of contact if the web site information differs from the stored, baseline web site information

13. The method of claim 12, wherein the encoded content comprises at least one calculated hash value.

14. The method of claim 12, wherein the web site information transmitted by the web detection agent is encrypted.

15. The method of claim 12, wherein the web detection agent authenticates the request for the web site information.

16. The method of claim 12, wherein the web detection manager authenticates a response to the request for the web site information.

17. A method for protecting web site data, comprising the steps of:
running a web detection console program, wherein running the web detection console program comprises
specifying a web site to monitor,
specifying one or more web pages within the web site to monitor,
specifying the frequency with which the web site will be monitored,
specifying at least one person to be contacted if a change in at least one web page of the one or more web pages is detected, and
specifying a communication means for contacting the at least one person;
running the web detection manager program installed on a first computer, wherein running the web detection manager program comprises requesting web site information from a web detection agent program and processing the web site information to determine whether the content of the one or more web pages has been changed; and
running the web detection agent program installed on a second computer, wherein the first computer is in communication with the second computer over a network, wherein running the web detection agent program comprises transmitting the web site information to the web detection manager program, and wherein the web site information comprises the encoded content of the one or more web pages.

18. The method of claim 17, wherein the communication means comprises a two-way communication system that allows the at least one person to interact with the web detection manager.

19. The method of claim 17, wherein the web detection manager has determined that the content of the one or more web pages has changed, wherein the web detection manager contacts the at least one person using the communication means, wherein the communication means is a two-way communication system, wherein the web detection manager provides the at least one person via the two-way communication system an option to accept the change to the at least one web page or to restore an unaltered version of the at least one web page.

20. A web site integrity detection system, comprising:
a plurality of web servers;
a web site on each of the plurality of web servers;
one or more web pages within the web site;
a load balancer for distributing processing and communication activity across the plurality of web servers;
a web detection manager;
a web detection agent; and
a web detection console,
wherein the web detection console configures the web detection manager to monitor the web site, the web detection manager requests web site information about the one or more web pages from the web detection agent and processes the web site information to determine whether the content of the one or more web pages has been altered, and the web detection agent provides the web detection manager with the web site information by encoding the content of the one or more web pages of the web site and transmitting the encoded content to the web detection manager.

21. The system of claim 20, wherein the web detection manager determines that the content of the one or more web pages has been altered, wherein the web detection manager interacts with the load balancer to disable a web server of the plurality of web servers, and wherein the web server comprises the one or more altered web pages.
